(19) United States
(12) Patent Application Publication
(10) Pub. No.: US 2001/0009410 A1
(43) Pub. Date: Jul. 26, 2001

(54) Head-mounted display apparatus and information processing system

(76) Inventor: Takao Fujita, Yokohama-shi (JP)

Correspondence Address: FITZPATRICK CELLA HARPER & SCINTO, 30 ROCKEFELLER PLAZA, NEW YORK, NY, 10112, US

(21) Appl. No.: 09/750,786

(22) Filed: Jan. 2, 2001

(30) Foreign Application Priority Data
Jan. 24, 2000 (JP) 2000-14936

(51) Int. Cl. G09G 5/00

(52) U.S. Cl. 345/8

(57) ABSTRACT

An object of the present invention is to provide a head-mounted display apparatus capable of radio communication with a computer unit at low cost and in compact structure, and a system therewith. For accomplishing the object, a computer unit and a head-mounted display of the present invention have first and second radio transceivers capable of communication with each other. Further, image data to be displayed on a display body is generated by a graphics processing unit of the computer unit and is supplied in the form of a radio signal to the head-mounted display. Since the graphics processing unit generates only the image data of a changed portion in the display area, it becomes feasible to reduce volumes of the image data to be transmitted and use inexpensive, compact radio transceivers.

### BACKGROUND OF THE INVENTION

1. Field of the Invention

The present invention relates to a head-mounted display apparatus, an information processing apparatus using a head-mounted display as an external display device, and an information processing system comprised thereof.

2. Related Background Art

In recent years, the development of downsizing technology of personal computers facilitated carrying of computer units and leads to promotion of so-called mobile computing to use a computer unit at an objective place, e.g., outdoors. The downsizing of computer units is also expected to be further developed from now on with progress in the LSI technology and packaging technology.

There are, however, demands for large and high-definition monitors (displays) used in the computer units because of the necessity to present volumes of information processed inside the computer efficiently to users. Such demands do not except the compact and lightweight computer units designed with emphasis on portability. Research has been conducted to utilize a compact head-mounted display as a monitor of the computer unit in order to give a solution to such tradeoff demands.

An example of appearance of a head-mounted display is presented in FIG. 4. The head-mounted display is composed of a display unit 201 for the right eye, a display unit 202 for the left eye, and a head mounting mechanism 203 for mounting these display units in front of the user's eyes, and thus has the structure similar to spectacles. This head-mounted display is mounted on the user's head and images supplied from an external device (not illustrated) are displayed on the right-eye display unit 201 and on the left-eye display unit 202, so as to permit the user to visually recognize an image.

Inside each of the right-eye display unit 201 and the left-eye display unit 202, there are a transmissive or reflective, compact liquid-crystal display panel of about 1 to 3 centimeters diagonal and an optical system such as a prism or the like, in such arrangement that an image on the compact liquid-crystal display panel is guided to the user's eye. The user's eyes see an optically enlarged virtual image as if to view a large screen in front of the eyes. Therefore, the large display area with high resolution can be realized in the form of the compact and lightweight head-mounted display.

FIG. 5 is a cross-sectional view to show an example of structure of a reflective liquid-crystal display panel.

In FIG. 5, reference numeral 304 designates a silicon substrate, 303 a reflective sheet formed on the silicon substrate, 302 a liquid crystal forming each pixel, and 301 a glass sheet.

Polarization of light (direction of polarization) passing through the liquid crystal is controlled by applying a voltage to the liquid crystal forming the pixel 302.

Illuminating light 305, 306 is linearly polarized light having been transmitted by an unrepresented polarizer. In a light-transmitting mode of the liquid crystal no voltage is applied to the liquid-crystal pixel and the beam 307 rotates the direction of its polarization 90° during transmission and reflection in the liquid-crystal layer and then travels through a second polarizer not illustrated, to appear bright to the user.

In a light-blocking mode of the liquid crystal on the other hand, the voltage is applied to the liquid-crystal pixel and the beam 308 does not rotate the direction of its polarization during transmission and reflection in the liquid-crystal layer and thus is blocked by the second polarizer not illustrated, to appear dark to the user.

FIG. 6 shows an example of structure of a head-mounted display using the reflective liquid-crystal display panel. The structure illustrated in FIG. 6 can be applied to the internal configuration of the right-eye display unit 201 and the left-eye display unit 202 in FIG. 4.

Numeral 402 denotes a light source for illumination, which is comprised of light-emitting diodes of three colors, Red, Green, and Blue. Numeral 403 represents a first prism, 404 a reflective liquid-crystal display panel, and 405 a second prism.

The light from the light-emitting diodes 402, which is illuminating light to illuminate the reflective liquid-crystal panel 404, is reflected in the first prism 403 to impinge on the surface of the reflective liquid-crystal panel. The illuminating light travels through the liquid-crystal surface controlled in quantity of passing light according to image data and is reflected by the reflective surface. This reflected light travels through the first prism 403 and then is reflected by a surface of the second prism 405 to reach the user's eyes 401. The user observes the image as an enlarged virtual image 406 as illustrated.

Next described is RGB frame-time-division color display utilized in the compact reflective color liquid-crystal displays.

In order to obtain high-definition images on the compact liquid-crystal surface, the compact reflective liquid-crystal displays employ the time-division color display in which display periods of Red, Green, and Blue are provided in time division in one field display period, instead of the color display with an RGB color filter normally used in the large liquid-crystal displays. Since the liquid-crystal pixels are common to Red, Green, and Blue in the time-division method, the number of pixels is one third of that in the color filter method and the time-division method is thus more advantageous in downsizing.

FIG. 7 shows a timing chart of the frame-time-division color display. The combination of three light-emitting diodes of Red, Green, and Blue is used for illumination of the reflective liquid-crystal display and the light-emitting diodes are activated at their respective times indicated as LED Red, LED Green, and LED Blue in the figure. Each of Red, Green, and Blue emits light once in one frame period and the time of emission thereof is not more than one third of one frame period. Therefore, there exist three emission times of Red, Green, and Blue in one frame period.

In synchronism with the emission times, data of Red, Green, and Blue is written into a memory of a control circuit in the liquid-crystal display, and an image of Red, an image of Green, and an image of Blue are successively displayed. The images separated into Red, Green, and Blue are projected to the user's eyes in one frame as described, but the user's eyes can recognize them as an ordinary color image of mixture of Red, Green, and Blue, because the display times of the respective color images are short.

FIG. 8 is a block diagram to show the structure of a frame-time-division color liquid-crystal display device. Numeral 601 designates an image memory for storing a component of Red among the image data, 602 an image memory for storing a component of Green among the image data, 603 an image memory for storing a component of Blue among the image data, 604 an LED control for controlling on/off of each of the light-emitting diodes of Red, Green, and Blue, 605 a light-emitting diode module consisting of the light-emitting diodes of Red, Green, and Blue, 606 a display for presenting color display in the RGB frame-time-division method, and 607 a display driver functioning to accept the image data, decompose the data into the components of Red, Green, and Blue, write the components into the respective image memories 601 to 603, and control the liquid-crystal display 606 and the LED control 604.

The image data is decomposed into the components of Red, Green, and Blue in the display driver section and the components thus decomposed are written into the corresponding image memories 601 to 603. The image data of Red, Green, and Blue thus written is read out of the corresponding image memories of the respective colors in synchronism with the on timing of the respective light-emitting diodes of Red, Green, and Blue used for illumination and then is written into the liquid-crystal display 606. For example, the image data for Red is written into the liquid-crystal display 606 immediately before the on timing of the LED of Red and then the Red LED forming the LED module is lit up, thereby presenting the image of the Red component to the user's eyes.

FIG. 9 shows the structure of a combination of the display with an ordinary computer unit to generate the display image data. The structure of the computer unit is illustrated as to only portions associated with the generation and display of the image data and the other structure is omitted.

The image data prepared on a main memory (not illustrated) by CPU 701 is transferred through an internal bus of the computer such as PCI or AGP, to a graphics processing unit 703. The graphics processing unit 703 performs an operation on the image data to expand the data to a display image corresponding to the resolution of the display 704, and writes the result in an image memory 702.

The CPU rewrites only necessary parts in the contents of the image memory 702 on necessary occasions.

Regardless of this writing from the CPU 701 into the image memory 702, the display image data written in the image memory 702 is repeatedly read in the fixed period by the raster scan method to be displayed on the display 704. This scan period is set, for example, so that 60 read operations are carried out for one second and 60 frames per second are written in the display, whereby stable images can be displayed without flicker even on the CRT normally used as a display.

The transmission of the image data to the display can be made by a digital method for transmitting the contents of the image memory 702 in the digital form as they are or by an analog method for transmitting the RGB data of the image memory 702 in the form of analog signals after it is converted by respective D/A converters. In the case of the digital method of VGA (640×480 pixels) as an example of the resolution of the display, supposing each of RGB has the resolution of eight bits, the transmission rate of data to the display necessitates the transmission band of 640×480× 60 Hz×3 colors×8 bits=442 Mbit/sec.

FIG. 10 shows an example of structure where the head-mounted display of the frame-time-division color display method is used as a display of a computer unit. In FIG. 10, a chip set 801 for executing control of CPU and bus, a graphics processing section 804, and an image memory 802 are the same as the CPU and chip set 701, the graphics processing section 703, and the image memory 702 illustrated in FIG. 9. Further, an image memory 803 represents the image memories 601 to 603 of FIG. 8 all together and a display control 806 corresponds to the display driver 607.

The RGB image data of the raster scan repeated in the fixed period, which is outputted from the graphics processing unit 804, is decomposed into the respective components of Red, Green, and Blue in the display control 806 and stored in the image memory 803. The display control 806 further outputs this stored image data of Red, Green, and Blue in synchronism with the timing of the RGB frame-time-division color display and controls the LED control built in the display main body 808 to light up the light-emitting diodes of the three colors of R, G, and B to emit the illuminating light at required times.

Since the display body 808 is desirably compact and lightweight in terms of being mounted on the head, almost all components (the image memory 803, the display control 806, etc.) other than the mechanism for mounting the display on the head are constructed in a unit separate from the display body 808. The display body 808 is connected through a cable to the other components. It is common practice to construct a connection 805 between the graphics processing unit 804 and the display control 806 of a cable or to construct a connection 807 between the display control 806 and the display body 808 of a cable.

However, when the head-mounted display is used as the display, user's free motion is impeded by the connection of the cable between the computer unit and the head-mounted display and the connection cable clings to the user because of the user's action, which degrades convenience.

In order to solve this problem, it is conceivable to change the cable-connected part into radio connection, but it poses another problem of increase in size and cost of the structural part for the radio connection, because the volumes of the image data to be transmitted to the display are normally very large as described above.

### SUMMARY OF THE INVENTION

An object of the present invention is to provide a head-mounted display being applicable as a display device of a computer unit and constructed in inexpensive and compact structure of radio connection with the computer unit, and a system incorporating this head-mounted display.

A head-mounted display apparatus according to one aspect of the present invention is a head-mounted display apparatus comprising: display means; support means which supports the display means in front of user's eyes; and display control means which supplies display data to be displayed on the display means, to the display means, wherein the display control means comprises radio communication means and generates the display data, based on a signal received by use of the radio communication means.

The display means in this case is preferably constructed to implement color display by switching display between a plurality of predetermined monochrome displays. Further, the received signal is preferably image data and position information indicating a position of the image data in a display area which the display means can display.

An information processing apparatus according to another aspect of the present invention is an information processing apparatus comprising image data generating means which generates image data to be displayed on an external display device, and radio communication means which transmits the image data by a radio signal.

The image data generating means in this case is preferably constructed to generate image data of an area for change of display contents in a display area of the external display device.

An information processing system according to another aspect of the present invention is an information processing system comprising: a head-mounted display device comprising display means, support means which supports the display means in front of user's eyes, and display control means which supplies display data to be displayed on the display means, to the display means; and an information processing device which can use the head-mounted display device as an external display device, wherein the information processing device comprises image generating means which generates image data to be displayed on the head-mounted display device, and first radio communication means which transmits the image data by a radio signal, and wherein the display control means of the head-mounted display device comprises second radio communication means capable of communication with the first radio communication means, and the display control means generates the display data, based on the image data received from the first radio communication means.

The image data generating means in this case is preferably constructed to generate image data of an area for change of display contents in a display area of the display means. Further, the image data is preferably one including position information indicating a position of the image data in the display area of the display means. At the same time, the display means is preferably constructed to implement color display by switching display between a plurality of predetermined monochrome displays.

### BRIEF DESCRIPTION OF THE DRAWINGS

FIG. 1 is a block diagram to show the structure of a head-mounted display system according to an embodiment of the present invention;

FIG. 2 is a block diagram to show an example of structure of a radio transceiver in FIG. 1;

FIGS. 3A and 3B are diagrams to illustrate packet forms in radio transmission;

FIG. 4 is a diagram to illustrate an example of appearance of the head-mounted display;

FIG. 5 is a diagram to illustrate an example of structure of a reflective liquid-crystal display panel;

FIG. 6 is a diagram to illustrate an example of structure of a head-mounted display using the reflective liquid-crystal panel;

FIG. 7 is a diagram to illustrate a timing chart of the frame-time-division color display;

FIG. 8 is a diagram to illustrate a color liquid-crystal display device of the RGB frame-time-division method;

FIG. 9 is a block diagram to illustrate an example of structure of a computer unit; and

FIG. 10 is a block diagram to show an example of structure where the head-mounted display is used as a display device of a computer unit.

### DETAILED DESCRIPTION OF THE PREFERRED EMBODIMENT

A preferred embodiment of the present invention will be described hereinafter with reference to the drawings.

(System Configuration)

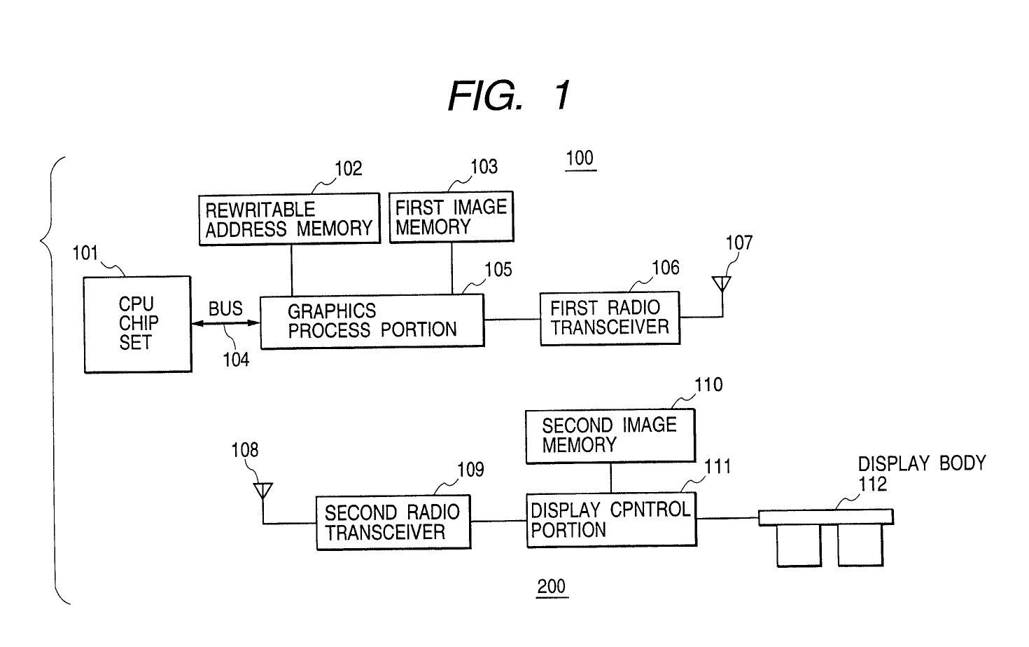

FIG. 1 is a block diagram to show an example of structure of an information processing system, which is an embodiment of the information processing system according to the present invention.

The computer system is comprised of a computer unit 100 and a head-mounted display 200 and radio connection is established between the computer unit 100 and the head-mounted display 200.

In the computer unit 100, reference numeral 101 designates a CPU and attendant chip set (which will be referred to hereinafter simply as CPU 101), 102 a rewritten address memory which temporarily stores address information of newly rewritten display image data, 103 a first image memory which temporarily stores the image data to be displayed, 104 an internal bus which connects the CPU 101 to the graphics processing unit 105, 105 the graphics processing unit which accepts a graphics command from the CPU 101 and which converts it into image data, 106 a first radio transceiver which transmits the display image data outputted from the graphics processing unit 105 in the form of a predetermined radio signal and which receives a signal from a second radio transceiver through an antenna 107, and 107 the first antenna through which the radio signal output from the first radio transceiver is sent into the space and through which the radio signal is received from the second radio transceiver 109.

In the head-mounted display 200, numeral 108 denotes a second antenna through which the radio signal output from a second radio transceiver 109 is sent into the space and through which the radio signal from the first radio transceiver is received, 109 the second radio transceiver for two-way transmission of radio data through the antenna 108, 110 a second image memory which stores the display image data in the form suitable for display on a liquid-crystal display incorporated in a display body 112, 111 a display control which periodically reads data out of the second image memory 110 to display it on the liquid-crystal display incorporated in the head-mounted display body 112 and which also receives the image data from the second radio transceiver 109 to update the contents of the second image memory 110, and 112 the head-mounted display body which presents the display image from the computer unit 100 to the user.

In the head-mounted display 200, the structure other than the display body 112 may be built in the display body or may be constructed, for example, to be hooked on a belt or the like, together with a secondary battery as a power supply, separately from the display body 112.

(Operation)

The operation will be described below.

The image data prepared in the CPU 101 is sent via the internal bus 104 such as the AGP or the PCI to the graphics processing unit 105. The graphics processing unit 105 executes a predetermined operation on the image data thus received to convert it to the image data in the form suitable for display, and writes the data in the first image memory 103.

Then the processing unit 105 stores the address information corresponding to the image data written in the first image memory 103, in the rewritten address memory 102.

Therefore, when the entire area in the display screen is rewritten, all the contents in the first image memory 103 are rewritten and addresses of rewritten data corresponding to the entire area of one screen are also stored in the rewritten address memory 102.

Particularly, when a part of the screen is rewritten as frequently carried out during use of the computer unit, e.g., during execution of software with GUI using windows, only a portion corresponding to the rewritten portion is rewritten out of the contents of the image memory 103 and addresses of the rewritten portion are stored in the rewritten address memory 102.

The address data indicating the rewritten portion can be any form of address data, e.g., data using a combination of a start address and an end address of rewriting, data using addresses corresponding to coordinates of the left upper corner and the right lower corner in the case of the rewritten area being a rectangle like the inside of a window, or the like. Of course, all the rewritten addresses may also be stored on an individual basis.

Further, it is also possible to preliminarily divide the data of one screen into blocks of predetermined units, designate block numbers to the respective blocks, and use a block number or the like as the address data indicating the rewritten portion.

Although FIG. 1 shows the separate blocks of the rewritten address memory 102 and the first image memory 103, the memories may be separate memories or separate areas on a single memory in practice.

The information for rewriting the display screen, stored in the rewritten address memory 102 and in the first image memory 103, is transmitted in the form of a radio signal to the head-mounted display 200 by use of the first radio transceiver 106 and the first antenna 107. Then the radio signal is received by the second antenna 108 and the second radio transceiver 109 in the head-mounted display 200.

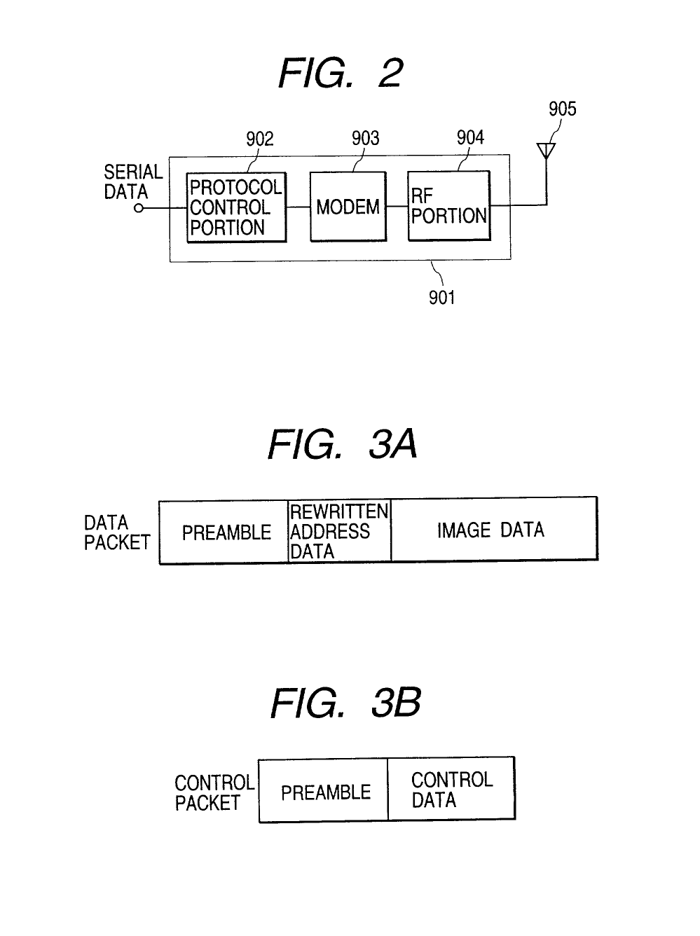

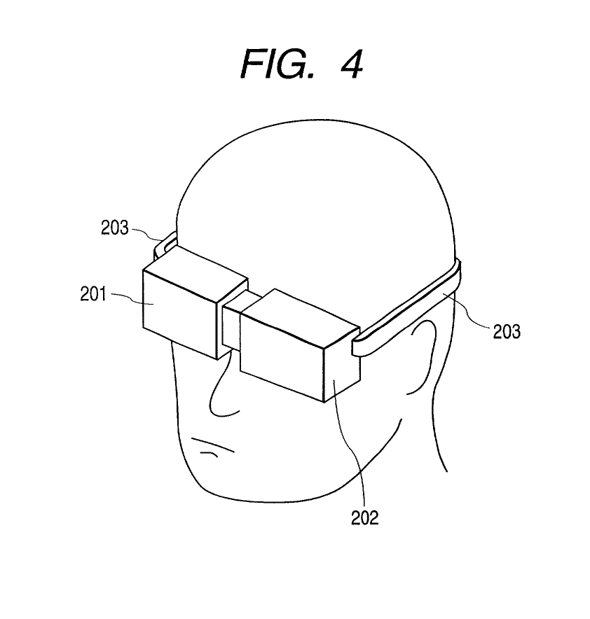

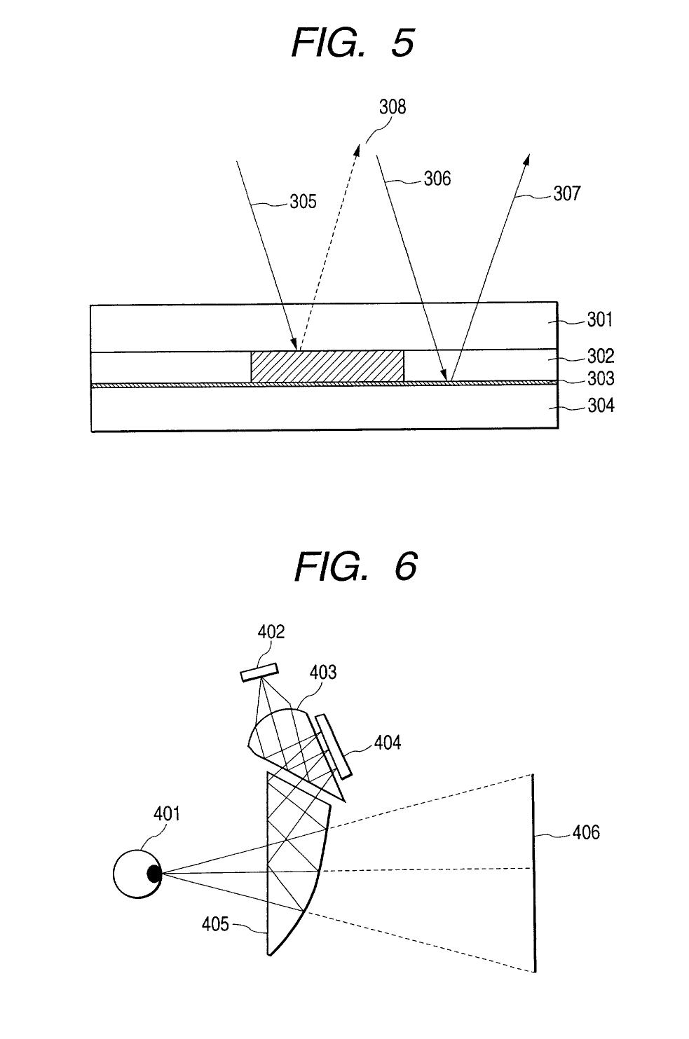

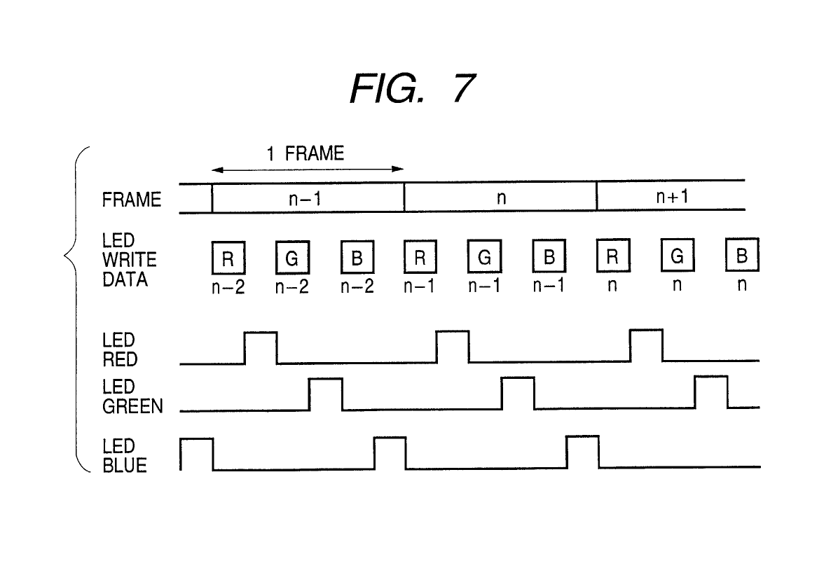

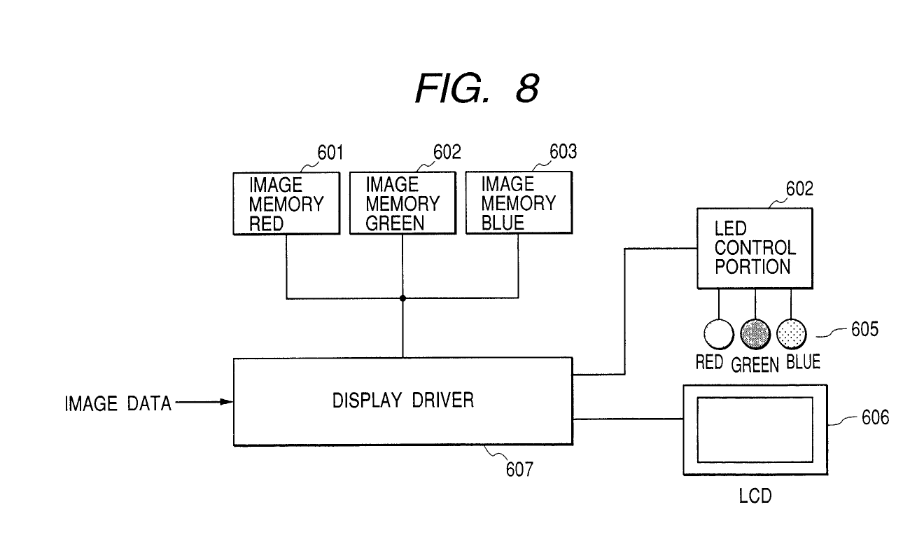

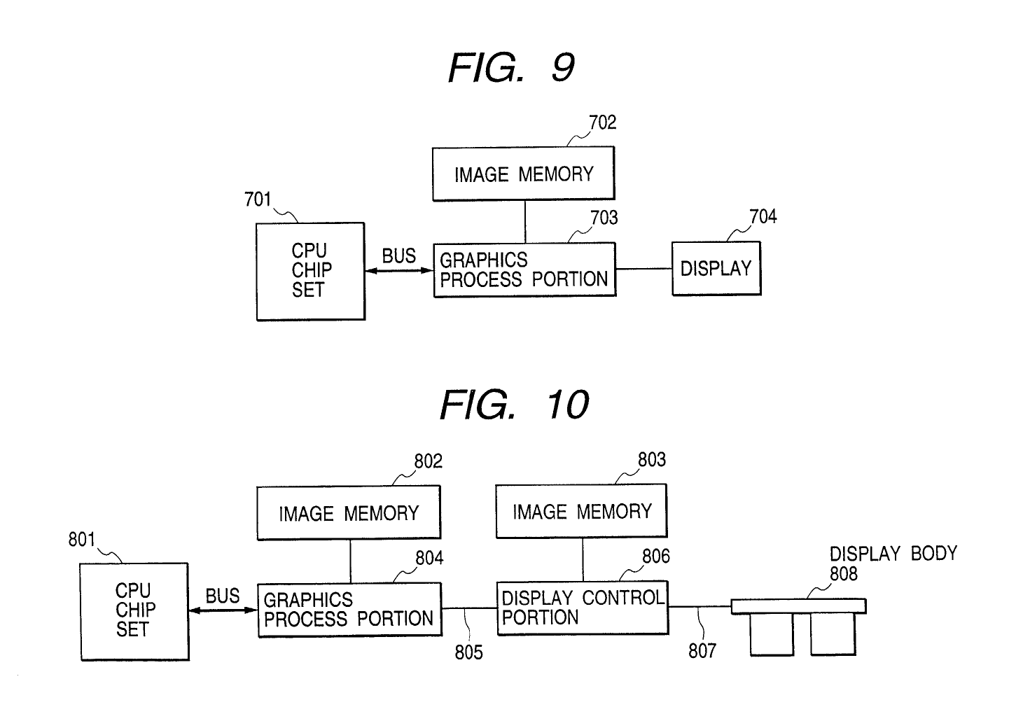

This radio transmission operation will be described below. The first radio transceiver 106 and the second radio transceiver 109 have the same internal structure illustrated in FIG. 2. The image data received from the graphics processing unit 105 by the first radio transceiver 106 is converted into a data packet of a configuration as illustrated in FIG. 3A, in a protocol portion 902 and the data packet is sent to a modem 903. The data packet is one packet formed by placing a preamble of communication control data necessary for the synchronizing operation on the receiver side or the like, as a header, and attaching changed address data of image and changed image data thereafter.

This data packet is subjected to data modulation for radio transmission, e.g., the phase modulation in the modem 903 of the post stage. Then this modulated signal further undergoes frequency conversion from the base band signal to a radio-frequency signal in an RF portion 904 of the post stage and the converted signal radiates as a radio wave through the first antenna 905 into the space.

On the other hand, the reverse operation is carried out on the occasion of reception by the second radio transceiver 109. Namely, the second antenna 108 captures the radio wave radiating from the first antenna 905 and the RF portion 904 performs the frequency conversion from the radio-frequency signal to the base band signal. Then the base-band modulated signal is demodulated in the modem 903 into the same packet data, illustrated in FIG. 3A, as that when transmitted. Further, the protocol portion 902 takes the changed address data and changed image data out of the data packet and outputs the data to the display control 111.

In the data transmission using the radio wave, the radio transmission paths are instable because of change in the ambience, such as obstacles, reflection, or the like and data cannot be always transmitted at a constant data transmission rate. It is thus necessary to give consideration to such circumstances that the second radio transceiver fails to receive the radio packet transmitted from the first radio transceiver. For that reason, the system employs a method of preparing a packet for control (control packet) as illustrated in FIG. 3B and sending the control packet informing of normal reception from the second radio transceiver to the first radio transceiver when the second radio transceiver normally receives the packet.

When the second radio transceiver sends no response within a predetermined time after the first radio transceiver sends the control packet in succession after the image packet, the same image data packet is again sent, which solves the problem of temporary reception failure.

Since the transmission of packet is changed according to the circumstances of the radio transmission paths in this way, transmission rates of data that can be transmitted through the radio transmitting means to the head-mounted display side are not constant.

For this reason, the transmission rate of data sent from the first image memory 103 through the graphics processing unit 105 to the first radio transceiver 106 is determined through transmission of the control packet between the first radio transceiver 106 and the second radio transceiver 109, and data to be transmitted is taken according thereto through the graphics processing unit 105 out of the rewritten address memory 102 and the first image memory 103.

In general, the radio data transmission is lower in speed than the cable transmission. However, since the system of the present embodiment is constructed to write the image data of the changed portion in the first image memory and thereafter transmit this data and address data together to the radio transceiver, the data received by the radio transceiver is the data of only the portion changed when the CPU changes the display image. When compared with the case wherein the image data is outputted in a fixed period (normally 60 to 85 Hz) of the raster image from the conventional graphics processing unit directly to the display, the data transmitted in the present embodiment is only data upon rewriting of a partial image, which is frequently utilized in use of a personal computer, and thus the structure is one suitable for relatively low-speed radio transmission. The protocol control portion 902 executes the generation of the control packet and the processing according to the contents thereof.

In the present invention the rates of radio transmission required of the first and second radio transceivers 106 and 109 vary depending upon the display resolution, the number of display colors, the contents of display (still image/moving picture), and so on, but the rates of approximately several hundred Kbps to several Mbps suffice for practical use, because rewriting of the entire screen is rare in normal use. The output power can also be small, because the distance is not so large between the computer device and the display in works using the computer. Examples of the radio transmission methods satisfying such conditions can be Bluetooth, IEEE802.11, and so on.

The changed address data and changed image data outputted from the second radio transceiver 109 is converted to a storage format of the second image memory 110 in the display control portion 111 to be saved.

The second image memory 110 is constructed to have separate memories or separate memory areas to save three frame images of Red, Green, and Blue, because the data of Red, the data of Green, and the data of Blue is separately written at the respective times into the liquid-crystal panel of the liquid-crystal display of the color time-division method incorporated in the display body 112.

The display control portion 111 sends the data of Red, the data of Green, and the data of Blue at the respective times to the liquid-crystal display of the color time-division method, thereby implementing the color display in the display body 112.

As described above, the present embodiment utilizes the radio communication between the head-mounted display and the computer device for generating the display image data thereof, which increases degrees of freedom in a mounted state of the display. In addition, since transmitted data volumes are reduced by the transmission of only the image data corresponding to the changed portion in the display image data, it becomes feasible to downsize the circuitry necessary for the radio communication.

(Modifications)

In the above embodiment the image displayed on the display body 112 was an ordinary two-dimensional image, but in the case of the display body 112 consisting of the independent displays for the right eye and for the left eye, a stereoscopic image can also be displayed in such a manner that the image memory 110 stores the image data corresponding to the display for the right eye and the image data corresponding to the display for the left eye and that separate images with parallax are displayed on the two displays right and left.

The radio communication was described only in the case of use of the radio wave, but the radio communication with light may also be employed if the sending and receiving operations can be carried out on a stable basis.

As described above, according to the present invention, the head-mounted display usable as a display device of the computer unit is constructed to be able to receive the image data for display via the radio signal, whereby there is no need for use of a connection cable between the computer unit and the head-mounted display and whereby the user can freely move while wearing the display.

What is claimed is:

1. A head-mounted display apparatus comprising:
display means;
support means which supports the display means in front of user's eyes; and
display control means which supplies display data to be displayed on said display means, to said display means,
wherein said display control means comprises radio communication means and generates said display data, based on a signal received by use of said radio communication means.

2. The head-mounted display apparatus according to claim 1, wherein said display means is display means which implements color display by switching display between a plurality of predetermined monochrome displays.

3. The head-mounted display apparatus according to claim 1 or claim 2, wherein said received signal is image data and position information indicating a position of said image data in a display area which said display means can display.

4. An information processing apparatus comprising image data generating means which generates image data to be displayed on an external display device, and radio communication means which transmits said image data by a radio signal.

5. The information processing apparatus according to claim 4, wherein said image data generating means generates image data of an area for change of display contents in a display area of said external display device.

6. An information processing system comprising:
a head-mounted display device comprising display means, support means which supports the display means in front of user's eyes, and display control means which supplies display data to be displayed on said display means, to said display means; and
an information processing device which can use the head-mounted display device as an external display device,
wherein said information processing device comprises image generating means which generates image data to be displayed on said head-mounted display device, and first radio communication means which transmits said image data by a radio signal, and
wherein said display control means of said head-mounted display device comprises second radio communication means capable of communication with said first radio communication means, and said display control means generates said display data, based on said image data received from said first radio communication means.

7. The information processing system according to claim 6, wherein said image data generating means generates image data of an area for change of display contents in a display area of said display means.

8. The information processing system according to claim 6 or claim 7, wherein said image data includes position information indicating a position of said image data in the display area of said display means.

9. The information processing system according to claim 6 or claim 7, wherein said display means is display means which implements color display by switching display between a plurality of predetermined monochrome displays.

10. The information processing system according to claim 8, wherein said display means is display means which implements color display by switching display between a plurality of predetermined monochrome displays.
